(19) United States
(12) Patent Application Publication
(10) Pub. No.: US 2008/0196812 A1
(43) Pub. Date: Aug. 21, 2008

(54) Tire With Tapered Bead and Method of Making Tires

(75) Inventors: Kenneth B. Turvey, Clinton, NY (US); Paul D. Gatley, Holland Patent, NY (US)

Correspondence Address: BOND, SCHOENECK & KING, PLLC, ONE LINCOLN CENTER, SYRACUSE, NY, 13202-1355, US

(73) Assignee: BARTELL MACHINERY SYSTEMS, LLC, Rome, NY (US)

(21) Appl. No.: 12/032,215

(22) Filed: Feb. 15, 2008

Related U.S. Application Data
(60) Provisional application No. 60/889,963, filed on Feb. 15, 2007.

(51) Int. Cl. B60C 15/00; B29D 30/48

(52) U.S. Cl. 152/539; 156/136

(57) ABSTRACT

A tire with a tire bead having a cross sectional profile including a relatively wide base section and a top section that is tapered on at least one side, with the tire bead being embedded directly in the tire body without the use of an extension. Also, a tire with a tire bead having a cross sectional profile including a relatively wide base section and a top section with one tapered side and one untapered side, with the tire bead being embedded in the tire body along with an extension. Also, a method of building a tire where the tire bead and extension are assembled into the tire body at the tire building drum of the tire assembly machine, and the tire bead and extension are not pre-assembled prior to being introduced onto or into the tire body.

### RELATED APPLICATION

The present application claims priority to U.S. provisional patent application No. 60/889,963, filed on Feb. 15, 2007; all of the foregoing patent-related document(s) are hereby incorporated by reference herein in their respective entirety(ies).

### BACKGROUND OF THE INVENTION

1. Field of the Invention

The present invention relates generally to tire beads that are used in pneumatic tires (see DEFINITIONS section), and more particularly to a tire bead geometry and manufacturing process useful in certain tire manufacturing processes.

2. Description of the Related Art

Conventional pneumatic tires include a tire body (see DEFINITIONS section), which may include, for example, a tread, a belt structure, and a carcass. The carcass generally includes at least one ply of fabric cords coated with an elastomer. Conventional tires also include tire beads, which are typically made of metal wire, or metal wire coated with a coating, such as uncured rubber. The tire beads are embedded in the tire body. These tire beads are ring shaped and run around the tire in the angular direction. There is generally one tire bead embedded in the vicinity of each cross-sectional end (see DEFINITIONS section) of the tire. The tire beads help secure the tire into a wheel assembly by engaging the rim of a wheel.

One common type of tire bead is called the single wire tire bead. With a single wire tire bead, a single wire, or coated wire, is wound through a plurality of turns in the angular direction to form the ring shape. FIG. 1 shows a cross section (cross hatching omitted for clarity of illustration) of a single wire tire bead having a cross section (see DEFINITIONS section) honeycomb wire center geometry, with each circle representing one turn of the wire. Very often, tire beads having this honeycomb wire center geometry will be coated with uncured rubber (not shown), or other elastomer, so that: (i) the starting stock has a hexagonal outer profile; and (ii) the adjacent hexagons nest in a honeycomb pattern in order to obtain the staggered row geometry shown in FIG. 1. Less common is the orthogonal wire center geometry shown in FIG. 2. Preferably, when using the orthogonal wire center geometry the wire is coated with uncured rubber (sometimes called insulation), but the profile of the coating is preferably round in orthogonal wire center geometry tire beads.

Besides single wire beads, ribbon, or weftless, type beads are also conventional. Ribbon type beads are built by turning a ribbon that has a row of discrete wires embedded in it into a ring shape. There are other types of beads, too. For purposes of this document, single wire tire beads are generally preferred, but other bead types may also be possible to use in some of the inventive embodiments discussed herein.

Tire beads are typically combined with an extension strip (also sometimes called an apex or filler) to: (i) physically reinforce the tire bead; (ii) reduce stresses on the tire body in the vicinity of the tire bead; and/or to help secure it within its embedded location in the tire body. The extension strip may be made of, for example, hard rubber). In conventional methods of assembling a tire, the tire bead and extension strip are conventionally connected to each other first (for example, by stitching) to form a bead subassembly. After this, the tire body and bead subassembly are brought together, and then the tire body is wrapped around the bead subassembly to embed it within the tire body and make the tire.

U.S. Pat. No. 4,922,985 (“Gasowski”) discloses, at FIG. 3, a tire having a bead, but no extension (or apex). This bead of FIG. 3 Gasowski has tree sections: (i) a main section of circular profile; (ii) a U-shaped section under the circular section; and (iii) a tapered top section (which appears to be similar to clamping member 231 of FIG. 2 Gasowski). A carcass ply separates the three sections of the FIG. 3 Gasowski tire bead. This means that FIG. 3 Gasowski's tire bead is made of at least three separate wires and is not a single wire tire bead. Gasowski may require two or more winders to make the multiple wire tire bead it shows in its FIG. 3.

U.S. Pat. No. 5,058,649 (“Hoang”) discloses a tire including: (i) bead core 11; (ii) clamping member 18; (iii) stiffening members 19, 20; and (iv) tire body 12, 13, 14, 15, 16, 17. As shown in FIG. 1 of Hoang, bead core 11 is a honeycomb geometry tire bead having cross sectional shape including: (i) a roughly trapezoidal base section; and (ii) a tapered section on top of the base section. It is noted that the tapered section of the Hoang tire bead: (i) has a honeycomb geometry; and (iii) has two tapered sides (not just one tapered side). Stiffening member 19 is not directly next to and/or touching bead core 11. Rather ply 12 and clamping member 18 are located between bead core 11 and stiffening member 19. Hoang does not disclose that its bead core is built on a tire building drum.

An example of a conventional tire including a tire bead and an extension (or apex) is disclosed in U.S. Pat. No. 5,253,692 (“Stephens”). As shown at FIGS. 1, 3 and 4 of Stephens, the Stephens tire includes: (i) bead hoops 4, 5 having an orthogonal geometry; and (ii) bead apexes 17. Stephens discloses the following: “The [Stephens] tire . . . comprises a bead hoop 5 of the 6×4 creel type. Any normal bead may be used including one formed from a single wire wound several times around a former so that only two ends occur. A carcass ply 15 is wrapped in an axially outward direction around the bead hoop 5 to form an edge turn-up 16 and a bead apex of triangular cross section 17 is positioned upon the bead hoop 5 as shown.” Stephens does not disclose that its bead core is built on a tire building drum.

US patent application 2003/0106627 (“Tonezzer”) discloses a tire that includes: (i) bead core 110; (ii) bead filler 111; and (iii) tire body (components shown if FIG. 1 of Tonezzer besides 110 and 111). As shown in FIGS. 1 and 5 of Tonezzer, bead core 110 is a honeycomb geometry tire bead having cross sectional shape including: (i) a roughly rectangular base section; and (ii) a tapered section on top of the base section. It is noted that the tapered section of the Tonezzer tire bead: (i) is two turns across at its narrowest section; (ii) has a honeycomb geometry; and (iii) has two tapered sides (not just one tapered side).

US patent application 2005/0161141 (“Nakagawa”) discloses a tire that includes: (i) tire body portion 6; (ii) bead core 5; and (iii) bead apex 8. As shown in FIGS. 2 and 5 of Nakagawa, the Nakagawa bead core and Nakagawa bead apex are pre-assembled into a tire bead assembly prior to being assembled into the Nakagawa tire body.

US patent application 2006/0108053 (“Hart”) discloses a method and apparatus for applying an apex at a workstation of a pneumatic tire building machine. In the Hart method, one or more bead area components have been built into an in-process carcass on a tire building drum of the tire building machine. Hart does not disclose that its bead core is built on a tire building drum.

US patent application 2007/0113954 (“Downing”) discloses a method of producing a tire. Downing discloses: “FIGS. 4A-4C illustrate the assembly of the tire components on a tire building drum of the tire of FIG. 3. . . . A first bead 114a and optional apex 116a is set over the toeguard 140a, liner 112 and ply end 122. Then a second layer of ply 130 is applied so that one end 134 of the second ply layer is located inside second bead 114b while the second end 132 extends laterally outwards therefrom. A second bead 114b and optional apex 116b is set over the second toeguard 140b, liner 112 and second layer of ply 130. The beads are preferably locked in place on the tire building drum.” A this disclosure is understood, the Downing method first pre-assembles a tire bead and extension into a tire bead assembly, and then assembles the tire bead assembly into the tire body.

Various other tire bead assembly methods and/or tire bead geometries are disclosed in the following: (i) U.S. Pat. No. 6,228,198 (“Powell”); (ii) U.S. Pat. No. 6,363,988 (“Yasufuku”); (iii) U.S. Pat. No. 6,413,342 (“Yun”); (iv) U.S. Pat. No. 6,524,416 (“Kubinski”); (v) US patent application 2003/0029573 (“Franke”); and (vi) US patent application 2007/0256790 (“Nijhuis”).

The published article “VMI and Marangoni to offer flexible tyre building system” in the European Rubber Journal (Vol. 187, No. 2: March/April 2005; by David Shaw, ERJ staff, herein “the First ERJ Article”) describes a recently developed tire manufacturing assembly process (herein “the ERJ process”). The ERJ process utilizes cells in which the tire building process is highly automated. In the ERJ process, tire beads and extensions are preassembled to form tire bead assemblies, and these pre-assembled tire bead assemblies are then fed into the tire building process. The tire beads utilized in the ERJ process are conventional tire beads, single wire or weftless. Because pre-assembled tire bead assemblies must be used in the ERJ process, this requires: (i) additional tire bead assembly machinery; (ii) additional tire bead assembly time; (iii) additional tire bead assembly expense; and/or (iv) increased process complexity.

The article “VMI's ultra-flexible tyre-making machine comes to life” in the European Rubber Journal (Vol. 188, No. 6: Global Tyre report 2006; herein “the Second ERJ Article”) describes a tire manufacturing system.

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

Some embodiments of the present invention provides a single wire tire bead that includes a reinforcing top section and a stable base section. The tire bead comprises a base section with several rows and columns of aligned wire passes, and a top section that is triangularly shaped, either in the form of a right hand triangle with the wire passes being vertically aligned with the wire passes in the base section, or a non-right hand triangle (e.g., equilateral, isosceles, scalene, etc.) where the top section is built by stepping the outer-most wire passes inwardly relative to the base section by about half the wire diameter. A servo or similar control system is utilized in conjunction with the pay-on head during the manufacturing process to dictate the cross sectional profile of the bead.

Some embodiments of the present invention is directed to a tire with a tire bead having a cross sectional profile including a relatively wide base section and a top section that is tapered on at least one side, with the tire bead being embedded directly (see DEFINITIONS section) in the tire body without the use of an extension. Preferably, these embodiments are single wire tire beads. Preferably, these embodiments have orthogonal wire center geometries. Preferably, these embodiments have a top section with one tapered side and one untapered side.

Some embodiments of the present invention is directed to a tire with a tire bead having a cross sectional profile including a relatively wide base section and a top section with one tapered side and one untapered side, with the tire bead being embedded in the tire body along with an extension. Preferably, these embodiments are single wire tire beads. Preferably, these embodiments have orthogonal wire center geometries. Preferably, the extension of these embodiments is relatively tall.

A method of building a tire where the tire bead and extension are assembled into the tire body at the tire building drum of the tire assembly machine (for example, a tire carcass drum of a tire building cell), and the tire bead and extension are not pre-assembled prior to being introduced onto or into the tire body.

Various embodiments of the present invention may exhibit one or more of the following objects, features and/or advantages:

(1) to provide a tire bead assembly having a profile that may be utilized in a tire building cell;

(2) to provide a tire bead building process that may be retrofit into existing tire building production processes;

(3) to provide a single wire bead profile that provides adequate support to the tire without having to use fillers or an apex;

(4) a tire bead assembly geometry and process that does not trap air within the tire body in the vicinity of the tire bead;

(5) to provide a tire bead assembly and associated manufacturing process with decreased machinery cost, reduced tire building time, reduced expense and/or reduced complexity; and/or

(6) to provide a tire without an extension (also sometimes referred to as an apex or filler or bead filler), and to associated materials cost and/or manufacturing cost and/or time savings.

According to one aspect of the present invention, a tire includes a tire body and at least tire bead. The tire bead is embedded directly (see DEFINITIONS section) in the tire body. The tire bead has a cross sectional profile including a base section and a top section. The top section includes at least one tapered side.

According to a further aspect of the present invention, a tire includes a tire body, at least tire bead, and an extension. The tire bead is embedded in the tire body. The tire bead has a cross sectional profile including a base section and a top section. The top section includes one tapered side and one untapered side. The extension has a bead interface surface. The extension is embedded in said tire body. The extension is oriented so that the bead interface surface is facing the tapered side of the tire bead.

According to a further aspect of the present invention, a method of building a tire includes steps identified as follows. One step is providing a tire building drum. Another step is placing starting stock for at least a portion of a tire body on the tire building drum. Another step, performed after the placing step, is feeding a tire bead onto the tire building drum. Another step is turning up a portion of said starting stock so that said tire bead is embedded in said tire body.

### BRIEF DESCRIPTION OF THE DRAWINGS

The present invention will be more fully understood and appreciated by reading the following Detailed Description in conjunction with the accompanying drawings, in which:

FIG. 1 is a cross sectional view of a first prior art tire bead;

FIG. 2 is a cross sectional view of a second prior art tire bead;

FIG. 3 is a schematic of a tire manufacturing line;

FIG. 4 is a cross-section profile of a first embodiment of a tire bead in accordance with the present invention;

FIGS. 5A and 5B are cross-section profiles of mirror images of a second embodiment of a tire bead in accordance with the present invention;

FIG. 6 is a representative view of the tire bead of the present invention positioned on a tire carcass before being wrapped;

FIG. 7 is a representative view of the tire bead of the present invention positioned on a tire carcass after being wrapped;

FIG. 8 is a cross section of a first tire bead assembly according to the present invention;

FIG. 9 is a cross section of a second tire bead assembly according to the present invention;

FIG. 10 is a cross section of a third tire bead assembly according to the present invention;

FIG. 11 is a cross section of a fourth tire bead assembly according to the present invention;

FIG. 12 is a cross sectional view of a tire building drum with a tire bead and extension according to the present invention;

FIG. 13 is a top view of a fifth tire bead assembly according to the present invention; and

FIG. 14 is a perspective view of a conventional bead line winder.

### DETAILED DESCRIPTION OF THE INVENTION

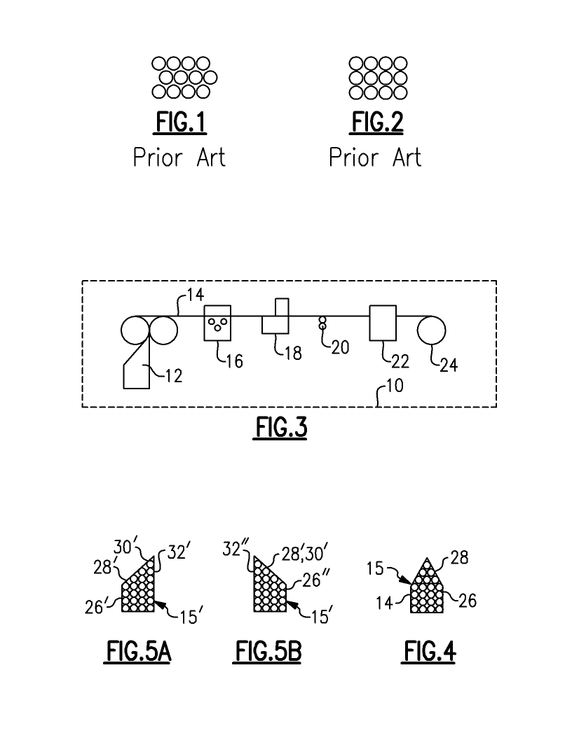

Referring now to the drawings, in which like reference numerals refer to like parts throughout, FIG. 3 shows a tire building assembly 10, including: (i) let-off stand 12 (from which wire 14 that will form a tire bead 15 is initially fed into the production line); (ii) preheater 16; (iii) extruder 18 (to coat the wire); (iv) roller assembly 20 (that shapes the wire to match the curvature of the bead to be assembled; (v) pay-on head 22; and (vi) tire carcass drum 24. The pay-on head is controlled via a servo, or equivalent system. The pay-on head loads the wire onto the tire carcass drum where the tire carcass is assembled. It is noted that no extension or apex is pre-assembled with the wire before it is fed onto the tire carcass drum.

The controller for pay-on head 22 is programmed to build the bead profile as a single wire tire bead in the desired geometry. With respect to some preferred embodiments of the present invention, the pay-on head is programmed to build the tire bead's cross sectional profile, as illustrated in FIGS. 4, 5A and/or 5B. Specifically, the cross sectional profile is built by repeated turns of the wire around the tire carcass drum to build up bead 15. Each of the three cross sectional profiles 15, 15′, 15″, respectively shown in FIGS. 4, 5A and 5B, includes: (i) base 26, 26′, 26″; and (ii) top section 28, 28′, 28″. The base has predetermined number of vertically and laterally aligned rows and columns, which arrangement is called an “orthogonal wire center geometry” in this document. Although the base sections 26,26′26″ of beads 15, 15′, 15″ are all rectangular in shape, as is preferred, the base section may have other shapes in some embodiments of the present invention.

The top section tapers inwardly, having fewer wires across in each successive row in the upwards direction. It is noted that the use of “top” and “upwards” here merely refers to the tire bead orientation shown in FIGS. 4, 5A and 5B—in assembled tires, the “top” section is oriented inwardly along the cross sectional direction (see DEFINITIONS section). In the preferred embodiments of FIGS. 4, 5A and 5B, the tapers taper down to a row that is a single wire across, but this is not necessarily required in all tapered top sections according to the present invention. Beads 15′ and 15″ are entirely according to an orthogonal wire center geometry, in both their base sections and top sections. Bead 15 has an orthogonal base section, but (as discussed below) a honeycomb top section. Generally speaking, an orthogonal wire center geometry is preferred for both the base and top sections, but there may be embodiments of the present invention that have honeycomb, or other non-orthogonal wire center geometries in their base section and or top section.

In FIG. 4, tire bead 15, top section 28 has a generally triangular shaped cross sectional profile, with each wire pass being stepped radially inward from the outer-most wires in the base section 26 by about half the wire diameter and there being one fewer radial wire passes for each layer as the bead is built upwardly (e.g., if the top layer of base section 26 has 4 wire passes, the first layer of top section 28 will have 3 wire passes, the next layer will have 2 wire passes and the top of top section 28 will have a single wire pass).

As explained above, tire bead 15 has an orthogonal wire center geometry such that each wire turn in a row is balanced on top of its corresponding wire turn in the row beneath it, creating: (i) a true orthogonal matrix (in both base section 26 and top section 28); and (ii) a true rectangular shape in base section 26). This can be done in a repeatable and reliable way. The technical challenge of an orthogonal wire center geometry is simply to be able to wind the bead while balancing one round wire on top of another. This can be accomplished by reducing the back tension on the wire as it is wound onto the bead former, so that the back tension does not pull the wire off the top of the wire in the layer below. Also, the pay-on-head (that's the part that steers the wire to change its position upon each revolution of the former) should be designed so that the wire movement is controlled with servo drive systems in both height and side ways movement. This process can be used to make wire beads having the cross sectional profiles of the present invention and also having orthogonal wire center geometries (in their base and/or top sections).

In the preferred embodiments of FIG. 5A, the cross sectional profile of tire bead 15′ includes base section 26′ and a top section 28′. The top section includes, in each of its rows, an outermost (right-side direction in orientation of FIG. 5A) wire pass that is at least substantially vertically aligned with the outermost (right-side direction in orientation of FIG. 5A) wire pass in base section 26′. This is what the word “untapered” means as used herein—it means that successive rows of a top section extend at least substantially as far as the longest row(s) of the base section on the untapered side. It is noted that some of the untapered side top section rows may not extend quite as far, such as when the top section has a honeycomb wire center geometry and the untapered side extends by a somewhat variable distance due to the non-alignment of wire centers in a honeycomb wire center geometry section. In the rectangular base embodiment 15′, the base section rows extend equally in the outer (right-side direction in orientation of FIG. 5A) direction. In other embodiments with a non-rectangular base, the untapered top section rows should extend as far as the base section rows that extend the furthest. For example, if the base section had a rounded bottom, then the untapered side of the top section should extend at least substantially out to the full radius of the rounded bottom.

In tire bead 15′, there are one fewer wire passes on the inner (left-side direction in orientation of FIG. 5A) side of the top section. Each row of the top section is still vertically aligned with the corresponding wire passes in base section 26′, but it is tapered on the inner side because the rows do not extend as far in the inner (left-side direction in orientation of FIG. 5A) direction as the corresponding rows of the base section—rather, the top section gets progressively narrower on its tapered side. Generally speaking, top section 28′ has a tapered side 30′ and an untapered side 32′. More specifically, top section 28′ includes, in essence, a right hand triangle formed on top of rectangular/square base section 26′. Top section 28′, like top section 28, serves to reinforce the bead, as would have been done by using an apex or other bead filler.

Tire bead 15″ of FIG. 5B is similar tire bead 15′ discussed above in connection with FIG. 5A, except that the tapered side 30″ and untapered side 32″ are reversed in left-right orientation with respect to the corresponding sides 30′, 32′ of FIG. 5A.

In tire manufacturing assembly 10 shown in FIG. 3, the pay-on head 22 is incorporated into a tire manufacturing cell, as described hereinabove and in the First ERJ article. This allows a complete tire to be built on a single fully automatic tire assembly machine, not requiring any components to be produced off-line. This also means that a pre-assembled bead and extension (herein called a tire bead assembly) is not required because the bead 15,15′, 15″ includes the geometry necessary for a secure tire without having to pre-assemble the bead and extension prior to feeding these components onto the tire carcass drum (sometimes also called a tire building drum). In addition, by using a programmable servo or other controller for the pay-on head 22, the bead manufacturing process is automated, thereby not adding to the labor expense of running the tire manufacturing cell.

FIG. 6 is a representative view of the tire bead of the present invention positioned on a tire carcass before being wrapped. FIG. 7 is a representative view of the tire bead of the present invention positioned on a tire carcass after being wrapped.

The geometry illustrated by FIGS. 4, 5A and 5B, including a stable base section 26,26′,26″ and a reinforcing top section 28,28′,28″, may lead to one or more of the following advantages: (i) no need for an extension; (ii) no need to be pre-assemble tire bead and extension before feeding these components onto a tire drum; and/or (iii) little or no air is trapped in the tire body during tire assembly. These three advantages will now be discussed in the following three paragraphs.

With respect to advantage (i), in some tire applications the tapered tire bead, whether a double sided taper or a single sided taper, can eliminate the need for a separate extension piece. For example, some tires for passenger vehicles have a construction and performance requirements such that no extension would be needed because the tapered top section of the tire bead is sufficient to provide the tire-related functionality that an extension is otherwise required to provide. Also, when the extension is eliminated, and the tire bead is a single wire tire bead, then only one winder will be required to make it, which reduces manufacturing time, manufacturing costs and/or complexity relative to tire beads made up of multiple wires.

With respect to advantage (ii), even tire applications that require an extension may be built by assembling the tire bead and the extension right on the tire carcass drum. As explained above, in the prior art tire bead assemblies having this kind of performance characteristics were typically pre-assembled by stitching an apex or other bead filler to the tire bead to form a pre-assembled tire bead assembly. This advantage (ii) is especially true of tire beads with a top section having a tapered side and an untapered side as shown in FIGS. 5A and 5B. As will be discussed below, it is not necessary to assemble the extension with the tire bead on the tire carcass drum, but the tire bead geometry of the present invention makes this possible when this assembly method is optimal from a cost, time and/or reliability perspective.

Further with respect to advantage (ii), each time a tire size is changed on a conventional tire assembly line, where the tire bead and extension are pre-assembled with each other, it is a relatively cumbersome procedure. The bead machine, extension machine and tire assembly need to be reset in the conventional set-up. This takes time out of and adds labor in to the manufacturing process. On the other hand, if the new style beads and any rubber extension are produced directly at the tire assembly machine according to the methods of the present invention, then only the tire assembly machine need be reset. For even quicker change-over times, the bead/extension parameters can be stored in memory. Also, according to the methods of the present invention exhibiting advantage (ii), the system is part of the tire assembly machine and builds the beads only as required no excess process stock is required to be manufactured.

With respect to advantage (iii), it is good to evacuate air from the following locations before the tire body is turned up and the tire bead and/or extension are embedded in the tire body: (a) between the tire bead and extension; (b) between the tire bead and tire body; and/or (c) between the extension and tire body. The tire bead geometry of FIGS. 5A and 5B, including a top section with one tapered side and one untapered side, is especially helpful for providing this advantage (iii) and reducing the trapped air, which could otherwise compromise the tire integrity. More specifically, trapped air can destroy the tire when it is heated or cured in the tire mold. This is true in embodiments that include an extension, as well as embodiments that do not. Advantage (iii) is an especially powerful advantage in embodiments where a relatively tall extension is required.

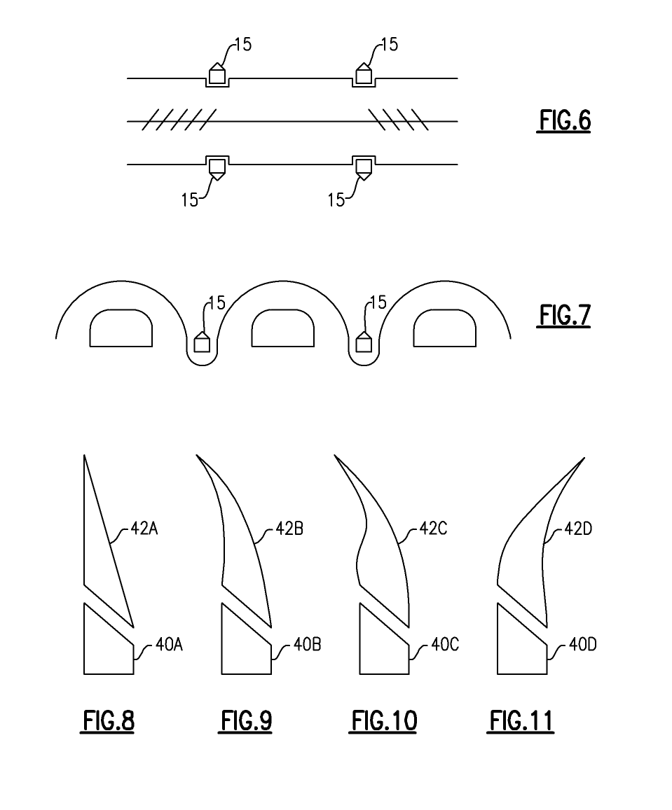

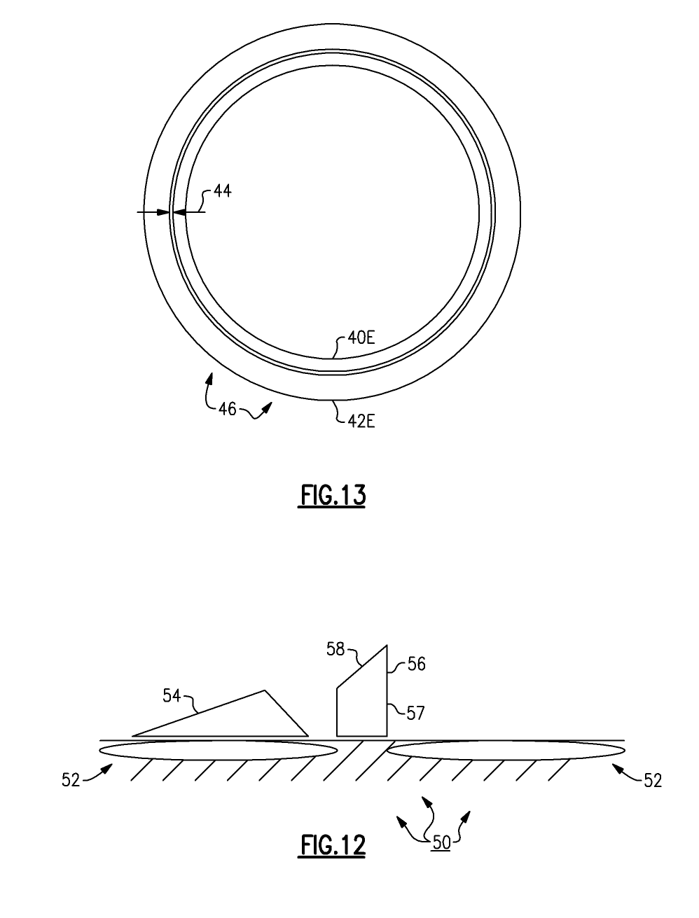

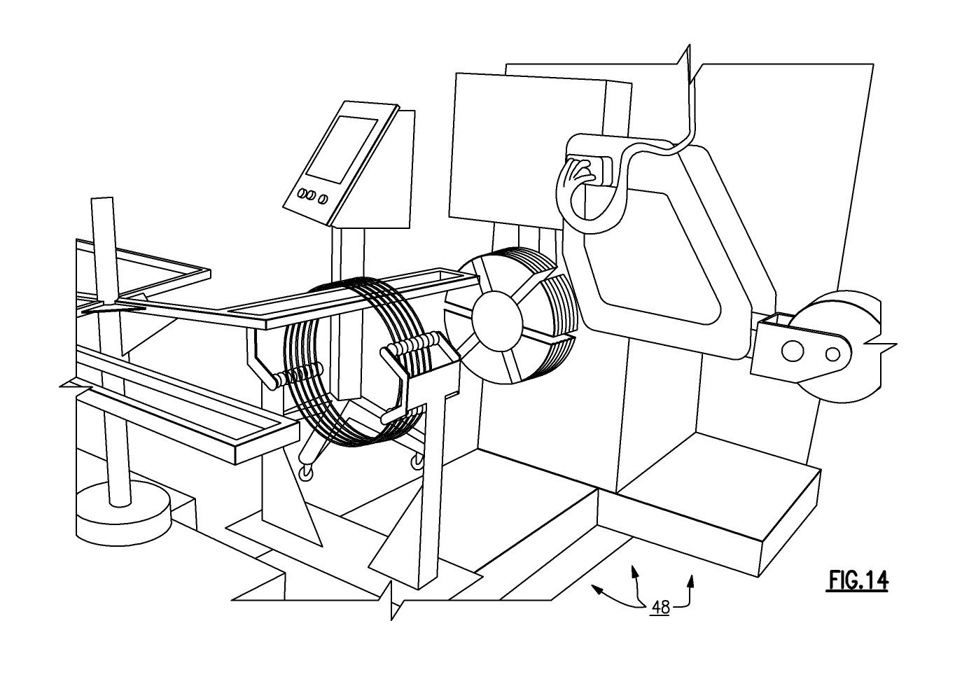

To further explain advantage (iii), one important advantage of at least some embodiments of the present invention is that the tire bead and tire apex can be fed onto the tire carcass drum in a cell based manufacturing assembly line without trapping air when the tire body is turned up to embed the tire bead and extension (preferably a rubber extension). Advantage (iii) will now be further explained with reference to FIGS. 8 to 12. FIGS. 8 to 11 each show a schematic cross section of a tire bead 40a-d and an extension 42a-d, where the extension is placed directly in contact with the tapered side of the tire bead. Extensions 42a-d show four examples of the range of cross sectional profiles that extensions according to the present invention may have. FIG. 12 shows a portion of a tire carcass drum (or, more generally, a tire building drum) 50, including: (i) bladders 52; (ii) extension workpiece 54; and (iii) tire bead workpiece 56. The tire bead workpiece includes generally rectangular base section 57 and top section 58, which is tapered on one side and not the other. The bladders are expanded to position components and/or shape the tire body from its flat tube starting stock configuration. As shown in FIG. 12, a space (not necessarily drawn to scale) is present between the extension workpiece and the tire bead workpiece. When the bladder is expanded, air can trapped between these two pieces when they are made according to conventional designs. However, when the tire bead and extension have the profiles according to the present invention, the tapered side of the top section and the engaging surface of the extension will seat together without trapping air.

Although many preferred embodiments of the present invention will not pre-assemble the tire bead and extension into a tire bead assembly prior to feeding these components onto a tire carcass drum, some embodiments of the present invention may still do this. Even in embodiments where the tire bead and extension are pre-assembled into a tire bead assembly, the tire bead geometries of FIGS. 5A, 5B and 8-11, with a tire bead with one tapered side that contacts the tire extension, can still prevent trapped air. FIG. 13 shows a tire bead assembly 46 that includes a pre-assembled: (i) tire bead 40e; and (ii) extension 42e. The bead and extension contact each other in the zone 44, where the tire bead has a tapered side (which is obscured by the extension in FIG. 13). Pre-assembled tire bead assemblies according to the present invention, such as that shown in FIG. 13, can be built on a conventional bead line winder, including a conventional former. For example, a conventional bead line winder can typically build 6 beads per machine cycle. A conventional bead line winder 48, including a conventional former is shown at FIG. 14.

To repeat and/or expand on some of the points discussed above, there are usually two tire beads and two extensions in each tire. The size and shape of the extension varies from tire type to tire type with short profile representing in FIG. 4 being generally more preferred in passenger tires applications. High performance passenger tires that are low profile designs preferably have very short apex profiles. The tire bead designs according to the present invention will exhibit a slope in the tapered side(s) of the top section depending upon: (i) wire diameter; (ii) wire coating; and/or (iii) the wire center geometry (for example, orthogonal, honey comb). The bead wire(s) diameter will preferably vary from one tire design to another with the ultimate selection being made by the tire designer.

### DEFINITIONS

The following definitions are provided to facilitate claim interpretation and claim construction:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Tire: any member flexible adapted to be fit onto a wheel assembly and contain compressed fluid (for example, compressed air); by its shape, a tire will define an angular direction, a radial direction, an axial direction and a central axis; unless otherwise noted, tires are not limited by: (i) the type of wheel assembly the tire is adapted to fit into; (ii) the type of vehicle or other device the tire may be adapted for; (iii) tire material; (iv) tire size; (v) existence of tread and/or tread type; and/or (vii) number of constituent pieces or materials.

Tire body: all parts of the tire exclusive of any bead(s) or extensions(s); tire bodies may include, but are not limited to, treads, belts and/or a carcass.

Cross section, cross sectional: unless otherwise noted herein, this refers to a cross section of a tire taken in a plane along both the axial and radial directions; generally speaking, the cross section of the tire will be substantially the same at any angular position, so the cross section will not generally specify an angular position herein; cross sectional direction shall mean the direction along the tire cross section, for example, in the Stephens patent, cross sectional direction would be the direction along the centerline of the hatched area in FIG. 1 and FIG. 2, running from reference numeral 6 to reference numeral 7 in each Figure.

Embedded directly mean a tire bead that is embedded in a tire body without an extension being embedded along with it.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A tire comprising:
a tire body;
at least one single wire tire bead embedded directly in said tire body, with said tire bead having a cross sectional profile including a base section and a top section and with said top section including at least one tapered side.

2. The tire of claim 1 comprising a second single wire tire bead embedded directly in said tire body, with said second tire bead having a cross sectional profile including a base section and a top section and with said top section including at least one tapered side.

3. The tire of claim 1 wherein said single wire tire bead comprises:
a wire; and
a coating over said wire.

4. The tire of claim 3 wherein said coating comprises uncured rubber.

5. The tire of claim 3 wherein said single wire tire bead has an orthogonal wire center geometry.

6. The tire of claim 3 wherein said single wire tire bead has a honeycomb wire center geometry.

7. The tire of claim 1 wherein the tire is sized and shaped for use in a passenger vehicle.

8. The tire of claim 1 wherein said top section includes one tapered side and one untapered side.

9. The tire of claim 1 wherein said top section includes two tapered sides.

10. A tire comprising:
a tire body;
at least tire bead embedded in said tire body, with said tire bead having a cross sectional profile including a base section and a top section and with the top section including one tapered side and one untapered side; and
an extension, having a bead interface surface, embedded in said tire body and oriented so that said bead interface surface is facing said tapered side of said tire bead.

11. The tire of claim 10 wherein said tire bead is a single wire tire bead.

12. The tire of claim 11 wherein said single wire tire bead comprises:
a wire; and
a coating over said wire.

13. The tire of claim 12 wherein said single wire tire bead has an orthogonal wire center geometry.

14. The tire of claim 12 wherein said single wire tire bead has a honeycomb wire center geometry.

15. The tire of claim 10 wherein said extension is made of a resilient material.

16. The tire of claim 15 wherein said extension is made of hard rubber.

17. A method of building a tire including the steps of:
providing a tire building drum;
placing starting stock for at least a portion of a tire body on said tire building drum;
after the placing step, feeding a tire bead onto said tire building drum; and
turning up a portion of said starting stock so that said tire bead is embedded in said tire body.

18. The method of claim 17 further comprising the step of, after the placing step, feeding an extension onto said tire building drum, wherein said extension is embedded in said tire body along with said tire bead at said turning up step.

19. The method of claim 18 wherein:
said tire bead has a cross sectional profile including a base section and a top section and with the top section including at one tapered side and one untapered side; and
said extension, has a bead interface surface; and
at said turning up step, said bead is oriented so that said bead interface surface is facing said tapered side of said tire bead.

20. The method of claim 19 wherein the feeding a tire bead step comprises the step of building up a tire bead on said tire building drum from a single wire.
